(19) United States
(12) Patent Application Publication
(10) Pub. No.: US 2002/0128847 A1
(43) Pub. Date: Sep. 12, 2002

(54) Voice activated visual representation display system

(76) Inventor: Anthony Ancona, Bayside, NY (US)

Correspondence Address: Richard W. Goldstein, 2071 Clove Road, Staten Island, NY, 10304, US

(21) Appl. No.: 09/804,997

(22) Filed: Mar. 12, 2001

(51) Int. Cl. G10L 21/00

(52) U.S. Cl. 704/275

(57) ABSTRACT

A voice activated visual pattern display unit, comprising a voice recognition unit, a pattern recognition unit, a phrase library, and a display generator. Input speech is recognized with the voice recognition unit. Phrases within the speech are isolated by the pattern recognition unit and are compared to the phrases within the phrase library. When a match occurs between the phrase within the speech and the phrase within the library, images associated with that phrase in the library are transferred to the display generator, which then allows the images to be displayed on a display unit.

### BACKGROUND OF THE INVENTION

The invention relates to a voice activated visual representation display system. More particularly, the invention relates to a system which monitors a spoken description of an event as it takes place, and then recreates a visual representation of that event and renders the visual representation on a display device.

Since the turn of the twentieth century, people have listened to oral accounts of events taking place in far-off locations. Essentially since the invention of the radio, man has had the ability to communicate directly and instantaneously with others far away. In addition to hearing reports of battles, political events, and social events, people have listened intently to “play-by-play” accounts of sporting events of all kinds.

As people began paying close attention to radio broadcasts of sporting events, the art of “sports casting” began developing. An expert sportscaster would fully describe the action as it was taking place and make the listeners feel almost as if they were actually watching the event.

As television became available to the masses, people were suddenly able to view the action themselves. However, sports casting has remained an important part of sports reporting. Many people still “listen to the game” on the radio while driving in cars, at work, and laying on the beach, etc. Accordingly, radio broadcasts of sporting events are still widely available.

Although the technology is clearly available to televise any event, not all events are televised. Budgetary concerns and bandwidth limitations make it difficult to provide televised broadcasts of every sporting event at all times. Accordingly, many fans are forced to listen to a radio broadcast.

Many devices have been promulgated which use voice recognition to control different devices in the real world, as well as to control the operations of a computer system. While these units may be suitable for the particular purpose employed, or for general use, they would not be as suitable for the purposes of the present invention as disclosed hereafter.

### SUMMARY OF THE INVENTION

It is an object of the invention to provide a visual display system which is capable of recognizing oral descriptions, interpreting the oral descriptions, and displaying visual representations based upon the interpretation of those descriptions.

It is a further object of the invention to provide a visual display system which is particularly suited for use with sporting events. Accordingly, the system recognizes common descriptions of common occurrences during a sporting event, and is capable of graphically recreating such occurrences.

It is yet a further object of the invention to allow users to provide their own descriptions of what they would like to see. Accordingly, a microphone is provided to give the user the ability to control the visually displayed graphical representations.

It is a still further object of the invention to enhance the enjoyment of the fan listening to the game. Accordingly, the visual representations of various events in the game are depicted to the user, who can then keep track of various occurrences in the game, while monitoring an audio report of the game.

The invention is a voice activated visual pattern display unit, comprising a voice recognition unit, a pattern recognition unit, a phrase library, and a display generator. Input speech is recognized with the voice recognition unit. Phrases within the speech are isolated by the pattern recognition unit and are compared to the phrases within the phrase library. When a match occurs between the phrase within the speech and the phrase within the library, images associated with that phrase in the library are transferred to the display generator, which then allows the images to be displayed on a display unit.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reference numerals. The drawings are briefly described as follows.

FIG. 1 is a top plan view, illustrating major components of the visual pattern display system.

FIG. 2 is a block diagram, illustrating the functional interconnection of various components of the visual pattern display system.

FIG. 3 is a flow diagram, providing an example of the display system in use.

FIG. 4 is a front elevational view of a display unit, showing a sample display according to the example of FIG. 3.

### DETAILED DESCRIPTION OF THE PREFERRED EMBODIMENTS

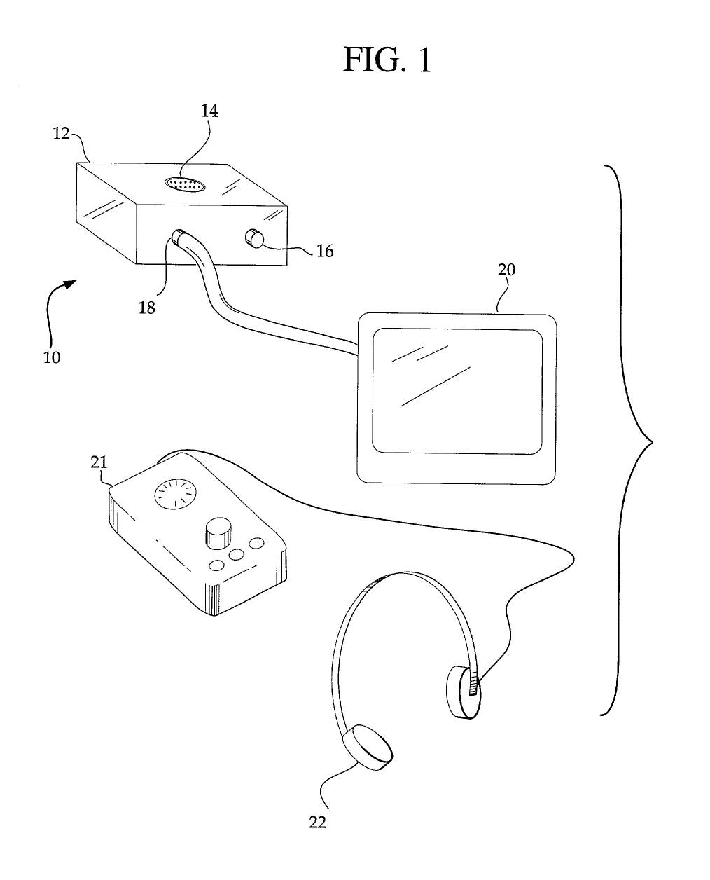

FIG. 1 illustrates a visual pattern display system 10, comprising a housing 12, having a microphone 14, a power input 16, and a video output 18. The visual pattern display system 10 is connected to a display unit 20, which may be a standard television, a video monitor, a computer monitor, or the like. Of course, different physical configurations may be provided, including those which include a display device within the housing 12, and which employ a headset type microphone. During typical usage of the display system 10, a separate radio 21, and accompanying headset 22 are often employed as described hereinafter.

In accordance with the present invention, sounds received by the microphone 14 are converted to an audio signal 30 thereby. The audio signal is deciphered by a voice recognition unit 32, which detects and recognizes patterns within the audio signal as speech, and more particularly, detects words within the speech. Such systems have been the subject of considerable study and development over the last several decades. Accordingly, no detailed explanation of the operation of voice or speech recognition technology is included in the present discussion. Of importance though, is that the speech recognition unit recognizes words, and outputs them in textual form or another suitable format.

Once the speech is broken down into words, a speech pattern recognition unit 34, compares isolates phrases within the speech and compares them with a phrase library 36. The phrase library 36 contains numerous phrases 38A and associated images 38B. When a close match with one of the phrases 38A is detected, the associated images 38B are sent to a display generator 40. The display generator 40 produces a video output signal 42, available at the video output 18 for display on an external display device.

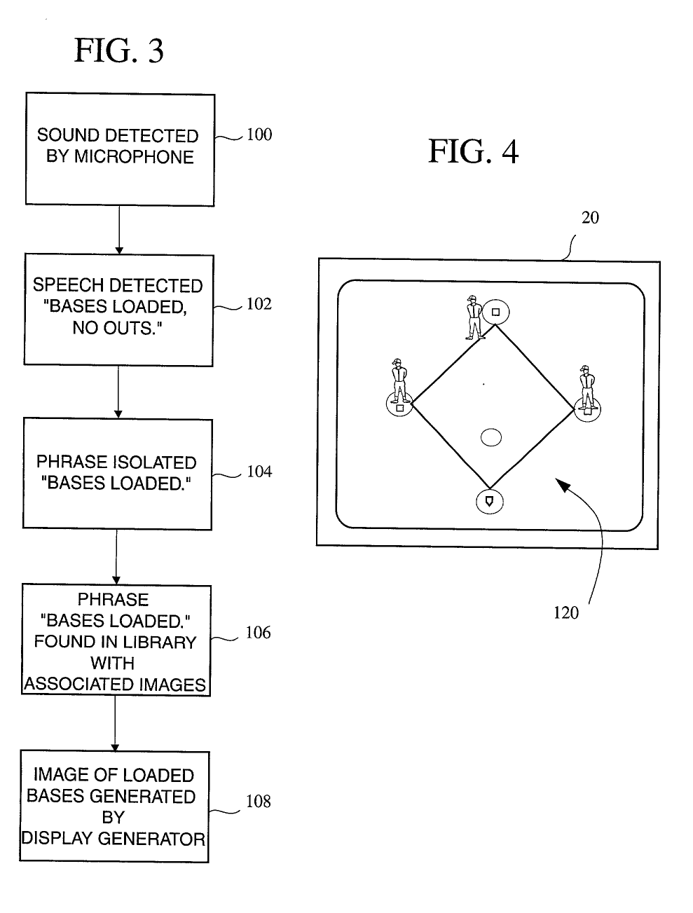

FIG. 3 and FIG. 4 provide a simplistic example of the system in use. Initially, the user speaks, and sounds are detected by the microphone 100. From these sounds, speech is detected, namely: “bases loaded, no outs” 102. From this speech, the phrase “bases loaded” is isolated. The isolated phrase “bases loaded” is searched in the library, and is found, along with associated images depicting ‘loaded bases’ 106. The images of ‘loaded bases’ are conveyed to the display generator 108, and the image of ‘loaded bases’ 120 is displayed on the display unit 20 as seen in FIG. 4.

The foregoing example provides the user with a static image of ‘loaded bases’ as a result. However, by the same process a series of images, in the form of a video clip, could be conjured up as well. For example, more complex phrases, such as “runner going to third, ball thrown to third, runner is out at third” could be broken into it's components of three individual phrases, which would then be displayed using the same principles as the foregoing example. Implementing such examples would simply involve increased complexity in terms of language analysis, phrase recognition, and in terms of the appropriateness of images selected to be displayed. Of course, artificial intelligence could be used to modify the images according to variations in the actual phrase spoken. For example if an actual player's name is spoken instead of “runner”, modifications could be made to the images, such that the depicted runner resembles the actual player's likeness, and is rendered having his actual jersey number, etc. Implementation of such an example and rendering the appropriate images would be no more complex or extraordinary than required by present day video games. Accordingly, the specific design and configuration of such a system would be well within the skill of one of ordinary skill in the art, and no further detail is required herein.

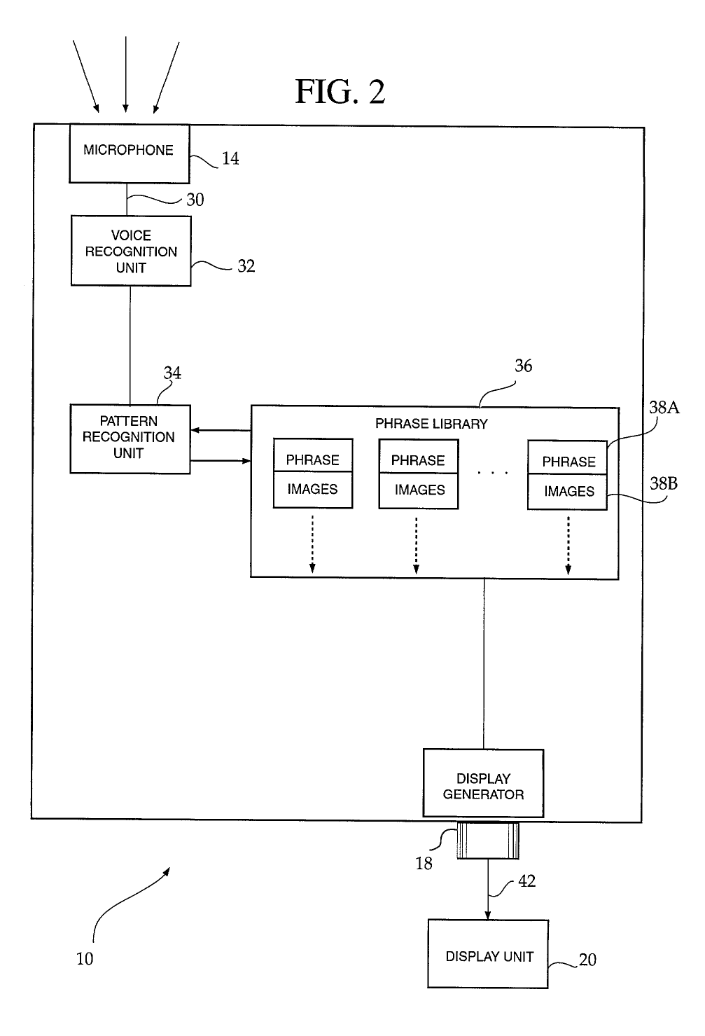

With regard to typical usage of the display device 10, the device 10 may be used to follow and enhance the enjoyment of a sporting event. The user listens to the sporting event, and oral descriptions of occurrences during the sporting event using the radio 21, and more directly, with the headphones 22. As the user chooses, he utters speech regarding different occurrences with the event that he would like to view. He speaks into the microphone 14, and thus begins operation of the display device as previously described, and as depicted in FIG. 2. However, to summarize, the uttered speech is recognized, and phrases within the speech are isolated and compared to phrases in the phrase library. Once a suitable match is found within the phrase library, images are displayed to the user on the display unit, thus providing him with a visual depiction of the occurrences uttered.

In conclusion, herein is presented a visual display device which by a preferred embodiment enhances the user's enjoyment of a sporting event by allowing him to see a visual depiction of events he has just heard about while listening to an audio account of the event. The foregoing description provides a workable example of the inventive concepts. However, it should be understood that the invention has been illustrated by example only. Numerous variations are possible, while adhering to the inventive principles. Such variations are contemplated as being a part of the present invention, limited only by the scope of the claims.

What is claimed is:

1. A display system, for creating an image on a display device using voice commands, and using a library having a plurality of phrases and images associated with each of said phrases, comprising the steps of:
detecting voice commands;
recognizing textual speech within the voice commands;
detecting a phrase within the textual speech;
comparing the detected phrase with phrases in the library;
displaying on the display device images described by the phrase by displaying on the display device images associated with the phrase in the library.

2. The display system as recited in claim 1, wherein the detected phrases are occurrences during a sporting event and wherein the displayed images depict those occurrences during the sporting event.

3. A display system, for use by a user to view images on a display unit having a video input, comprising:
a voice recognition unit, the voice recognition unit capable of determining words from input speech;
a phrase library, the phrase library storing a plurality of phrases and a plurality of images associated with the phrases;
a pattern recognition unit, the pattern recognition unit capable of isolating phrases from the words generated by the voice recognition unit, and comparing them to phrases within the phrase library;
a display generator, for generating a video signal to display images from the phrase library when the pattern recognition unit matches a phrase from the voice recognition unit with a phrase from the phrase library.

4. The display system as recited in claim 3, wherein the display system has a housing, and wherein a microphone is present at the housing, the microphone is in direct communication with the voice recognition unit.

5. A sporting event following method, for enjoying a sporting event by a person, using a display device having voice recognition and a display unit, comprising the steps of:
listening to an audio account of a sporting event regarding certain occurrences during said sporting event, said listening performed by the user;
uttering speech by the user regarding the occurrences during the sporting event;
detecting and isolating selected phrases within the uttered speech by the display device; and
displaying images to the user by the display device representing a visual depiction of the phrases spoken by the user.

6. The sporting event following method as recited in claim 5, further using a radio with headphones and wherein the step of listening to an audio account of a sporting event further comprises listening to the radio with the headphones.

7. The sporting event following method as recited in claim 7, using a phrase library having a plurality of phrases and images directly associated with the phrases, wherein the step of detecting and isolating the phrases further comprises the steps of:
recognizing textual speech within the uttered speech;
detecting a phrase within the textual speech;
comparing the detected phrase with phrases in the library; and
displaying on the display device images described by the phrase by displaying on the display device images associated with the phrase in the library.
